(19) United States
(12) Patent Application Publication
(10) Pub. No.: US 2025/0374087 A1
(43) Pub. Date: Dec. 4, 2025

(54) COMMUNICATION CONTROL METHOD, NETWORK NODE AND USER EQUIPMENT

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/299,163

(22) Filed: Aug. 13, 2025

Related U.S. Application Data
(63) Continuation of application No. PCT/JP2024/004848, filed on Feb. 13, 2024.

(30) Foreign Application Priority Data
Feb. 14, 2023 (JP) 2023-021066

(51) Int. Cl. H04W 24/02; H04W 8/22

(52) U.S. Cl. CPC H04W 24/02; H04W 8/22

(57) ABSTRACT

In an aspect, a communication control method is a communication control method in a mobile communication system. The communication control method includes a step of transmitting to a user equipment, by a base station, at least either of model information indicating information relating to a plurality of respective first AI/ML models or an execution condition indicating a condition for executing a predetermined operation for a plurality of respective second AI/ML models. Here, the base station holds the plurality of first AI/ML models, and the user equipment holds the plurality of second AI/ML models.

### RELATED APPLICATIONS

The present application is a continuation based on PCT Application No. PCT/JP2024/004848, filed on Feb. 13, 2024, which claims the benefit of Japanese Patent Application No. 2023-021066 filed on Feb. 14, 2023. The content of which is incorporated by reference herein in their entirety.

### TECHNICAL FIELD

The present disclosure relates to a communication control method, network node and user equipment.

### BACKGROUND

In recent years, the Third Generation Partnership Project (3GPP) (trade name), which is a standardization project for mobile communication systems, is studying to apply an Artificial Intelligence (AI) technology, in particular, a Machine Learning (ML) technology to wireless communication (air interface) in the mobile communication system.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In an aspect, a communication control method is a communication control method in a mobile communication system. The communication control method includes a step of transmitting to a user equipment, by a network node, at least either of model information indicating information relating to a plurality of respective first AI/ML models or an execution condition indicating a condition for executing an operation predetermined for a plurality of respective second AI/ML models. Here, the network node holds the plurality of first AI/ML models, and the user equipment holds the plurality of second AI/ML models.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example of the AI/ML technology according to the first embodiment.

FIG. 8 is a diagram illustrating an arrangement example of functional blocks of the AI/ML technology according to the first embodiment.

FIG. 9 is a diagram illustrating an example of reducing a CSI-RS according to the first embodiment.

FIG. 10 is a diagram illustrating an example of reducing the CSI-RS according to the first embodiment.

FIG. 11 is a diagram illustrating an operation example according to the first embodiment.

FIG. 12 is a diagram illustrating an arrangement example of the functional blocks of the AI/ML technology according to the first embodiment.

FIG. 13 is a diagram illustrating an arrangement example of the functional blocks of the AI/ML technology according to the first embodiment.

FIG. 14 is a diagram illustrating an arrangement example of the functional blocks of the AI/ML technology according to the first embodiment.

FIG. 15 is a diagram illustrating an operation example according to the first embodiment.

FIG. 16 is a diagram illustrating an arrangement example of the functional blocks of the AI/ML technology according to the first embodiment.

FIG. 17 is a diagram illustrating an operation example according to the first embodiment.

FIG. 18 is a diagram illustrating an operation example according to the first embodiment.

FIG. 19 is a diagram illustrating an example of a configuration message according to the first embodiment.

FIG. 20 is a diagram illustrating an operation example according to the first embodiment.

FIG. 21 is a table illustrating an example of model information according to the first embodiment.

FIGS. 22A and 22B each are a table illustrating an example of execution conditions according to a second embodiment.

FIG. 23 is a diagram illustrating an operation example according to the second embodiment.

FIG. 24 is a diagram illustrating an example of the priority according to the second embodiment.

### DESCRIPTION OF EMBODIMENTS

The present disclosure provides a user equipment which can appropriately perform model inference using an AI/ML model.

### First Embodiment

A mobile communication system according to a first embodiment will be described with reference to the drawings. In the description of the drawings, the same or similar parts are denoted by the same or similar reference signs.

### Configuration of Mobile Communication System

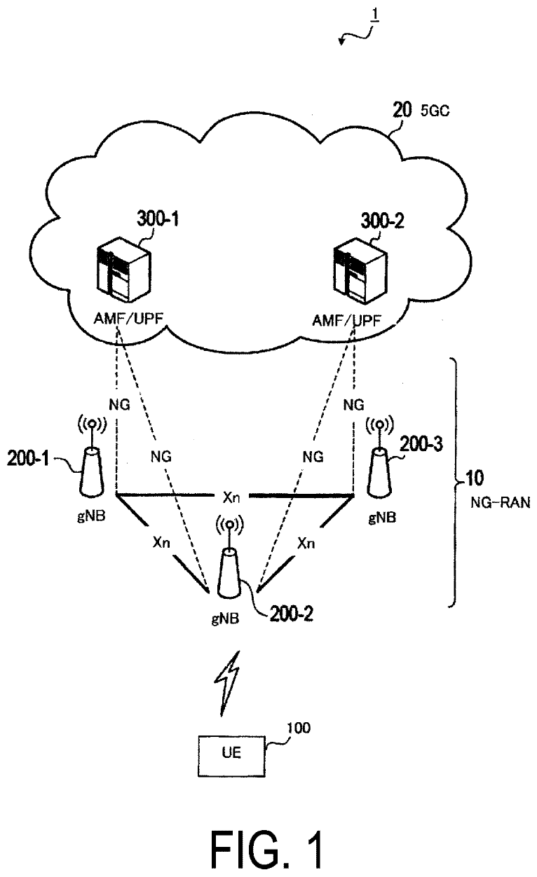

A configuration of a mobile communication system according to the first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a routing function of user data (hereinafter, simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between the base station and the core network. The AMF and the UPF 300 may be core network apparatuses included in the CN 20.

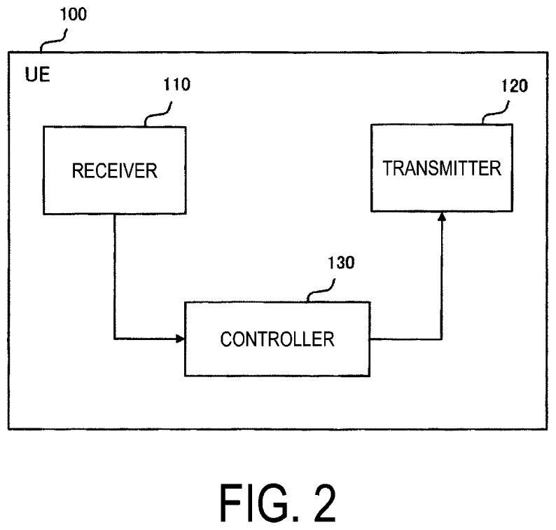

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

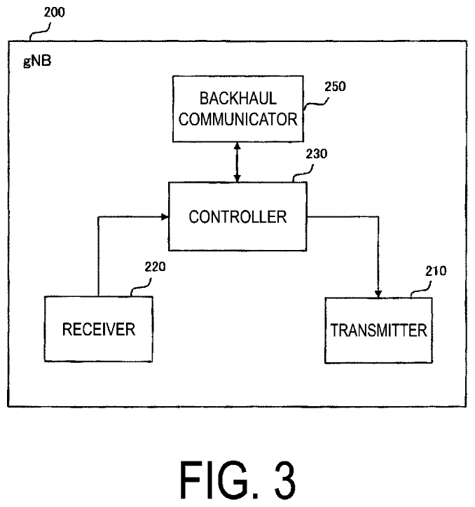

FIG. 3 is a diagram illustrating an example of a configuration of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between the base station and the core network. Note that the gNB 200 may include a central unit (CU) and a distributed unit (DU) (i.e., functions are divided), and the two units may be connected via an F1 interface, which is a fronthaul interface.

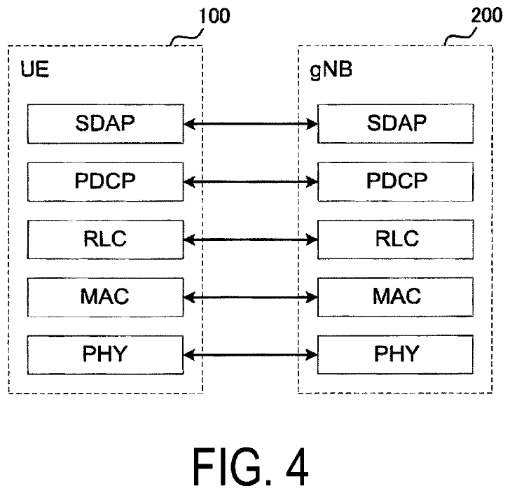

FIG. 4 is a diagram illustrating an example of a configuration of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. A Cyclic Redundancy Code (CRC) parity bit scrambled by the RNTI is added to the DCI transmitted from the gNB 200.

In NR, the UE 100 can use a bandwidth narrower than a system bandwidth (i.e., a cell bandwidth). The gNB 200 configures a bandwidth part (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of each of the BWPs may overlap with each other. When multiple BWPs are configured for the UE 100, the gNB 200 can designate which BWP to apply by control in the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QOS) control by the core network, and radio bearers, which are units for QoS control by the Access Stratum (AS). Note that, when the RAN is connected to the EPC, the SDAP need not be provided.

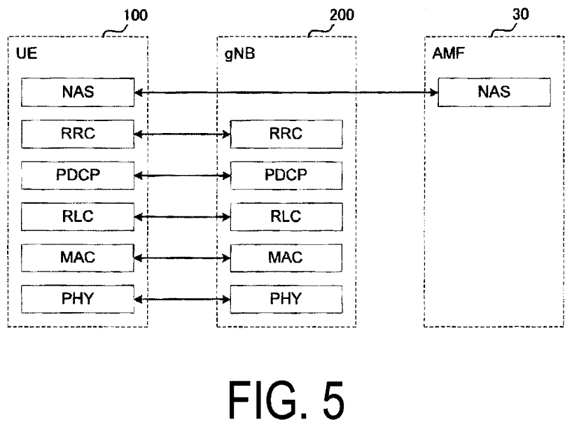

FIG. 5 is a diagram illustrating a configuration of a protocol stack of a radio interface

of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of the radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is ranked higher than the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as the Access Stratum (AS).

### AI/ML Technology

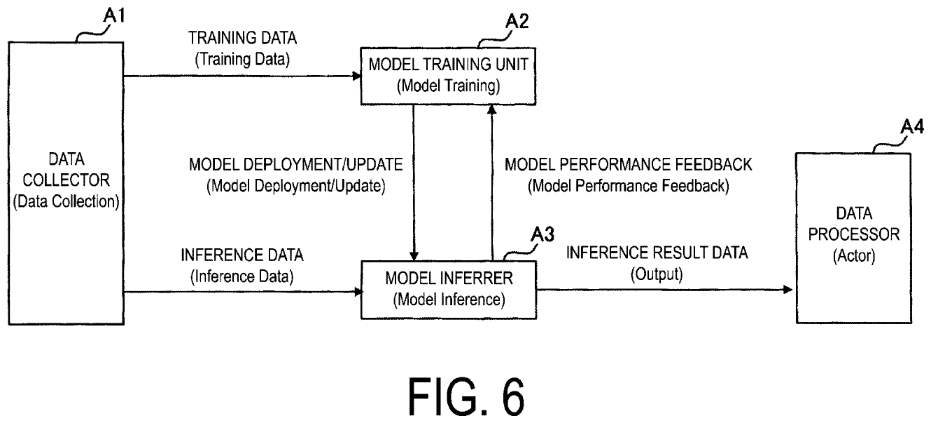

In the embodiment, an AI/ML technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model training unit A2, a model inferrer A3, and a data processor A4.

The data collector A1 collects input data, specifically, training data and inference data. The data collector A1 outputs the training data to the model training unit A2. The data collector A1 outputs the inference data to the model inferrer A3. The data collector A1 may acquire data in the apparatus in which the data collector A1 is provided, as input data. The data collector Al may acquire, as the input data, data in another apparatus.

The model training unit A2 performs model training. Specifically, the model training unit A2 optimizes parameters of the training model through machine learning using the training data, and derives (or generates, or updates) a trained model. The model training unit A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model training unit A2.

The data processor A4 receives the inference result data and performs processing that

utilizes the inference result data.

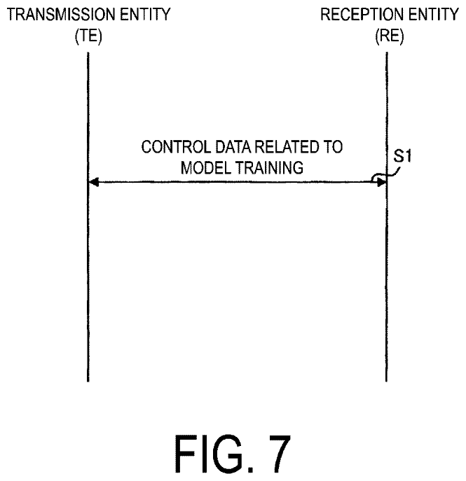

FIG. 7 is a diagram illustrating an operation example in the AI/ML technology according to the first embodiment.

A transmission entity TE is, for example, an entity in which machine learning is performed. The transmission entity TE derives a trained model by performing the machine learning. The transmission entity TE, then, generates inference result data as an inference result by using the trained model. The transmission entity TE transmits the inference result data to a reception entity RE.

On the other hand, the reception entity RE is, for example, an entity in which no machine learning is performed. The reception entity RE performs various processing by using the inference result data received from the transmission entity TE.

Note that the entity may be, for example, an apparatus. The entity may be, for example, a functional block included in an apparatus. The entity may be, for example, a hardware block included in an apparatus.

For example, the transmission entity TE may be the UE 100 and the reception entity RE may be the gNB 200 or a core network apparatus. Alternatively, the transmission entity TE may be the gNB 200 or a core network apparatus and the reception entity RE may be the UE 100.

As illustrated in FIG. 7, in step S1, the transmission entity TE transmits control data relating to the AI/ML technology to the reception entity RE, or receives control data from the reception entity RE. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. Downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.

### (1.1) Channel State Information (CSI) Feedback Enhancement

### (1.2) Beam Management

### (1.3) Positioning Accuracy Enhancement

Hereinafter, an arrangement example of the functional blocks will be described for each use case.

### (1.1) Arrangement Example of Functional Blocks in CSI Feedback Enhancement

The “CSI feedback enhancement” represents, for example, a use case where the machine learning technology is applied to the CSI fed back from the UE 100 to the gNB 200. The CSI is information relating to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

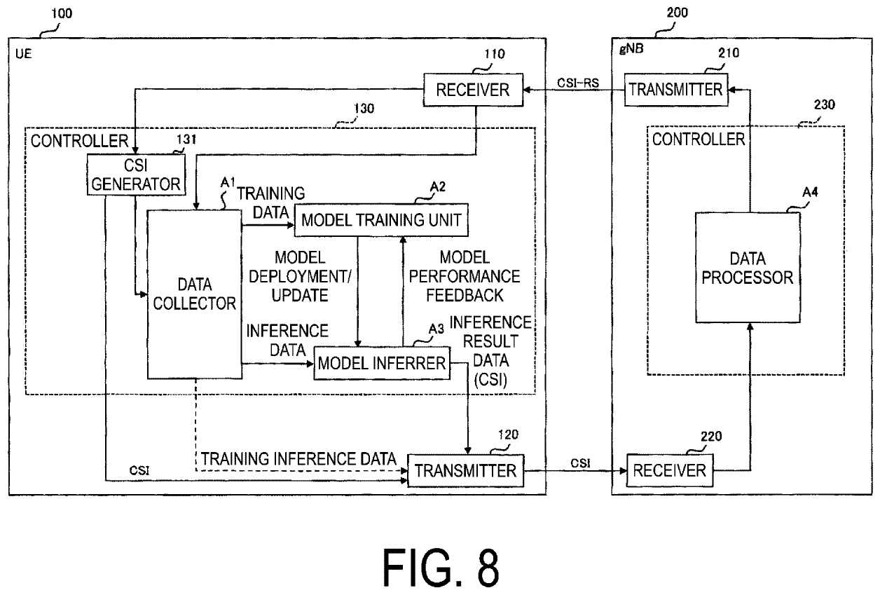

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model training unit A2, and the model inferrer A3. On the other hand, the controller 230 of the gNB 200 includes the data processor A4. That is, model training and model inference are performed in the UE 100. FIG. 8 illustrates an example in which the transmission entity TE is the UE 100 and the reception entity RE is the gNB 200.

The gNB 200 transmits a reference signal for the UE 100 to estimate a downlink channel state in the “CSI feedback enhancement”. The reference signal will be described below with a CSI Reference Signal (CSI-RS) as an example, but the reference signal may be a Demodulation Reference Signal (DMRS).

First, in the model training, the UE 100 (receiver 110) receives a first reference signal from the gNB 200 by using a first resource. The UE 100 (model training unit A2) derives a trained model for inferring the CSI from the reference signal by using training data including the first reference signal and the CSI. Such a first reference signal may be referred to as a full CSI-RS.

For example, a CSI generator 131 performs channel estimation by using the reception signal (CSI-RS) received by the receiver 110, and generates the CSI. The transmitter 120 transmits the generated CSI to the gNB 200. The model training unit A2 performs model training with a set of the reception signal (CSI-RS) and the CSI as the training data and derives a trained model for inferring the CSI from the reception signal (CSI-RS).

Second, in the model inference, the receiver 110 receives a second reference signal from the gNB 200 by using a second resource that is less than the first resource. The model inferrer A3, then, uses the trained model and infers the CSI as inference result data with the second reference signal as inference data. Hereinafter, such second reference signal may be referred to as a partial CSI-RS or a punctured CSI-RS.

For example, the model inferrer A3 inputs the partial CSI-RS received by the receiver 110 to the trained model as the inference data, and infers the CSI from the CSI-RS. The transmitter 120 transmits the inferred CSI to the gNB 200.

This enables the UE 100 to feed back (or transmit) the accurate (complete) CSI to the gNB 200 from a small number of CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

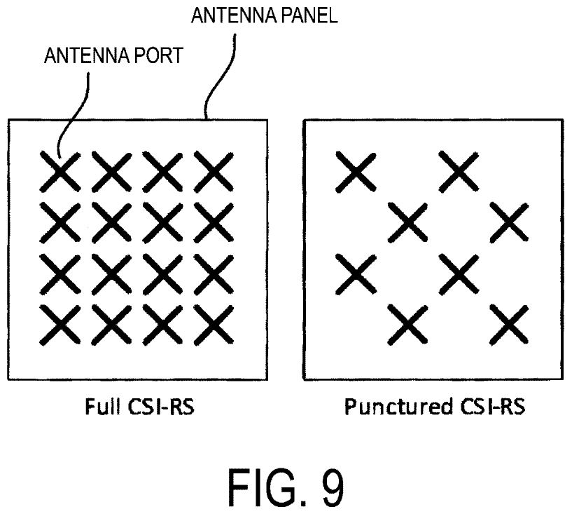

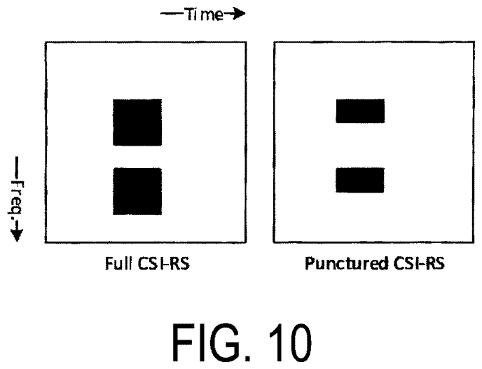

FIGS. 9 and 10 each are a diagram illustrating an example of reducing the CSI-RSs according to the first embodiment.

FIG. 9 illustrates an example in which the CSI-RSs are reduced by reducing the number of antenna ports for transmitting the CSI-RSs. For example, the gNB 200 performs the following processing. That is, the gNB 200 transmits the CSI-RSs from all the antenna ports of an antenna panel in a mode in which the UE 100 performs the model training (hereinafter, the mode may be referred to as a “training mode”). On the other hand, the gNB 200 reduces the number of antenna ports for transmitting the CSI-RSs and transmits the CSI-RSs from half the antenna ports of the antenna panel in a mode in which the UE 100 performs model inference (hereinafter, the mode may be referred to as an “inference mode”). Thus, the overhead can be reduced, use efficiency of the antenna ports can be increased, and a power consumption reduction effect can be obtained. Note that the antenna port is an example of the resource.

On the other hand, in FIG. 10, an example is illustrated in which the gNB 200 reduces radio resources for transmitting the CSI-RSs, specifically, time-frequency resources. For example, the gNB 200 performs the following processing. That is, the gNB 200 transmits the CSI-RSs by using the predetermined time-frequency resources when the UE 100 is in the training mode. On the other hand, the gNB 200 transmits the CSI-RSs by using less time-frequency resources than the predetermined time-frequency resources when the UE 100 is in the inference mode. Thus, the overhead can be reduced, use efficiency of the radio resources can be increased, and a power consumption reduction effect can be obtained.

As illustrated in FIGS. 9 and 10, the gNB 200 transmits the full CSI-RS using the predetermined number of the first resources, and transmits the partial CSI-RS using the second resources having less resources than the first resources.

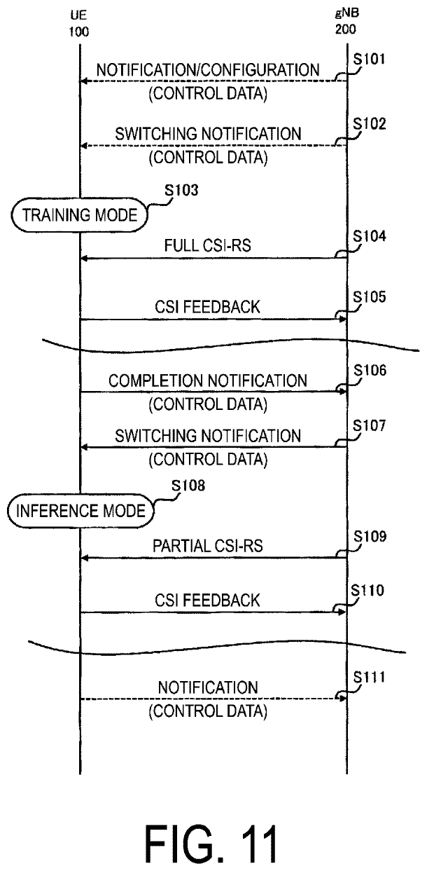

FIG. 11 is a diagram illustrating an operation example in the “CSI feedback enhancement” according to the first embodiment.

As illustrated in FIG. 11, in step S101, the gNB 200 may notify the UE 100 of or configure for the UE 100 a transmission pattern (puncture pattern) of the CSI-RS in the inference mode as control data. For example, the gNB 200 transmits, to the UE 100, the antenna ports and/or the time-frequency resources in which the CSI-RSs are transmitted or not transmitted in the inference mode.

In step S102, the gNB 200 may transmit a switching notification for starting the training mode to the UE 100.

In step S103, the UE 100 starts the training mode.

In step S104, the gNB 200 transmits a full CSI-RS. The receiver 110 of the UE 100 receives the full CSI-RS and the CSI generator 131 generates (or infers) the CSI based on the full CSI-RS. In the training mode, the data collector A1 collects the full CSI-RS and the CSI. The model training unit A2 creates a trained model with the full CSI-RS and the CSI as training data.

In step S105, the UE 100 transmits the generated CSI to the gNB 200.

Thereafter, in step S106, when the model training is completed, the UE 100 transmits a completion notification indicating that the model training is completed to the gNB 200. The UE 100 may transmit the completion notification when the creation of the trained model is completed.

In step S107, the gNB 200 transmits, to the UE 100, a switching notification for the UE 100 to switch from the training mode to the inference mode in response to the reception of the completion notification.

In step S108, the UE 100 switches from the training mode to the inference mode in response to the reception of the switching notification.

In step S109, the gNB 200 transmits a partial CSI-RS. The receiver 110 of the UE 100 receives the partial CSI-RS. In the inference mode, the data collector A1 collects the partial CSI-RS. The model inferrer A3 inputs the partial CSI-RS to the trained model as the inference data, and obtains the CSI as the inference result.

In step S110, the UE 100 feeds back (or transmits) the CSI, being the inference result, to the gNB 200 as inference result data. The UE 100 can generate a trained model with predetermined accuracy or higher by repeating the model training in the training mode. The inference result obtained by using the trained model deployed as described above is expected to have the predetermined accuracy or higher.

Note that, in step S111, when the UE 100 determines by itself that the model training is necessary, the UE 100 may transmit to the gNB 200 a notification indicating that the model training is necessary as the control data.

In the example illustrated in FIG. 11, an example has been described in which the training data is the “(full) CSI-RS” and the “CSI”, and the inference data is the “(partial) CSI-RS”. Hereinafter, the training data and/or the inference data may be referred to as a “data set”.

In the “CSI feedback enhancement”, for example, at least either of the following data or information may be used as the data set, in addition to the “CSI-RS” and the “CSI”.
(X1) Reference Signals Received Power (RSRP), Reference Signal Received Quality (RSRQ), Signal-to-interference-plus-noise ratio (SINR), or an output waveform of an AD converter (the measurement target thereof may be the CSI-RS or may be other received signals received from the gNB 200. The measurement target may be other reception signals received from the gNB 200)
(X2) Bit Error Rate (BER) or Block Error Rate (BLER) (BER (or BLER) may be measured based on CSI-RS with a total number of transmission bits (or a total number of transmission blocks) being known)
(X3) Moving speed of the UE 100 (which may be measured by a speed sensor in the UE 100)

What is used as the data set for the machine learning may be configured. For example, the following processing may be performed. That is, the UE 100 transmits capability information to the gNB 200 as the control data, the capability information indicating which type of input data the UE 100 can handle in the machine learning. The capability information may indicate, for example, any of data or information indicated in (X1) to (X3). The capability information may be information in which training data and inference data are separately designated. The gNB 200, then, transmits data type information used as the data set to the UE 100 as the control data. The data type information may indicate, for example, any of data or information indicated in (X1) to (X3). The data type information may separately be designated as data type information used as training data and as data type information used as inference data.

### (1.2) Arrangement Example of Functional Blocks in Beam Management

An arrangement example of functional blocks in “beam management” will be described. The “beam management” represents, for example, a use case where the machine learning technology is used for managing which beam is an optimum beam among the beams transmitted from the gNB 200.

In the “beam management”, the gNB 200 sequentially transmits beams having different directivities. Each beam includes, for example, a reference signal. The UE 100 measures reception quality of each beam by using the reference signal included in each beam. The UE 100 determines, for example, a beam with the best reception quality to be the optimum beam.

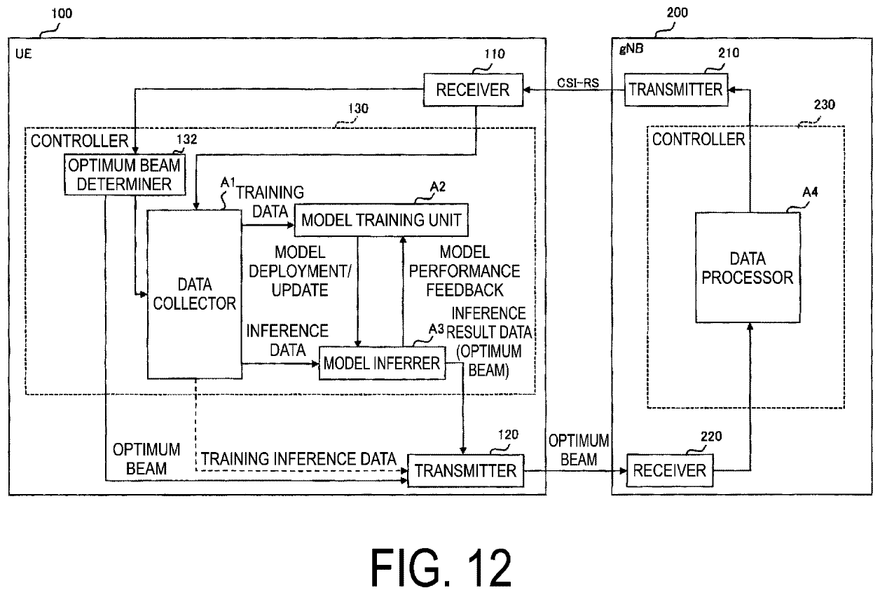

FIG. 12 is a diagram illustrating an arrangement example of each of the functional blocks in the “beam management”. In the example of the “beam management” illustrated in

FIG. 12, the controller 130 of the UE 100 includes the data collector A1, the model training unit A2, and the model inferrer A3. On the other hand, the controller 230 of the gNB 200 includes the data processor A4. That is, FIG. 12 illustrates an example in which the model training and the model inference are performed in the UE 100. FIG. 12 illustrates an example in which the transmission entity TE is the UE 100 and the reception entity RE is the gNB 200.

As illustrated in FIG. 12, the UE 100 includes an optimum beam determiner 132. The optimum beam determiner 132 determines the optimum beam based on, for example, the reception quality of the reference signal included in each beam. An example will be described in which the CSI-RS is used as the reference signal, as with the “CSI feedback”, but a Demodulation Reference Signal (DMRS) may be used as the reference signal. The transmitter 120 transmits information representing the determined optimum beam as the “optimum beam” to the gNB 200.

An operation example in the “beam management” can be implemented by replacing the “CSI feedback” with the “optimum beam” in FIG. 11.

In the training mode (step S103), the gNB 200 transmits beams with different directivities to the UE 100 (step S104). Each beam includes the full CSI-RS. In the training mode, the data collector A1 of the UE 100 collects the full CSI-RS and the optimum beam (information representing the optimum beam). The model training unit A2 creates a trained model with the CSI-RS and the optimum beam (information representing the optimum beam) as the training data. The full CSI-RS is an example of the first reference signal, and the partial CSI-RS is an example of the second reference signal.

In the inference mode (step S108), the gNB 200 sequentially transmits beams with different directivities. Each beam includes the partial CSI-RS. In the inference mode, the data collector A1 collects the partial CSI-RS. The model inferrer A3 inputs the partial CSI-RS to the trained model as the inference data, and obtains the optimum beam (information representing the optimum beam) as the inference result. The UE 100 transmits the inference result (optimum beam) to the gNB 200 as inference result data.

In the “beam management”, for example, at least either of the following data or information may be used as data that is used for the data set, in addition to the “CSI-RS” and the “optimum beam”.
(Y1) Synchronization Signal Block (SSB) received from the gNB 200
(Y2) RSRP, RSRQ, SINR, or an output waveform of the AD converter (the measurement target thereof may be CSI-RS or may be other received signals received from the gNB 200. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)

The UE 100 may transmit capability information to the gNB 200 as the control data, the capability information indicating which type of input data the UE 100 can handle in the machine learning. The capability information may include any information or data in (Y1) to (Y6). The capability information may include any information or data in (Y1) to (Y6), while separately handling the training data and the inference data. The gNB 200 may transmit data type information used as the data set to the UE 100 as the control data. The data type information may include, for example, any of data or information indicated in (Y1) to (Y6). The data type information may include, for example, any information or data in (Y1) to (Y6), while separately handling the training data and the inference data.

### (1.3) Arrangement Example of Functional Blocks in Positioning Accuracy Enhancement

An arrangement example of the functional blocks in “positioning accuracy enhancement” will be described. The “positioning accuracy enhancement” represents, for example, a use case where the accuracy of the position information measured by the UE 100 is enhanced using the machine learning technology.

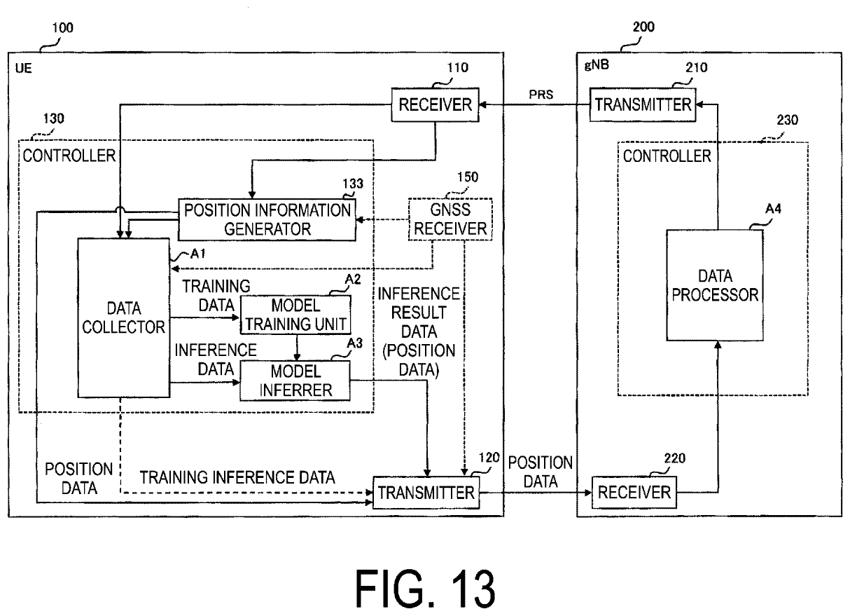

FIG. 13 is a diagram illustrating an arrangement example of the functional blocks in the “positioning accuracy enhancement”. In the example of the “positioning accuracy enhancement” illustrated in FIG. 9, the controller 130 of the UE 100 includes the data collector A1, the model training unit A2, and the model inferrer A3. On the other hand, the controller 230 of the gNB 200 includes the data processor A4. That is, FIG. 13 illustrates an example in which the model training and the model inference are performed in the UE 100. FIG. 13 illustrates an example in which the transmission entity TE is the UE 100 and the reception entity RE is the gNB 200.

As illustrated in FIG. 13, the UE 100 includes a position information generator 133. The UE 100 may include a Global Navigation Satellite System (GNSS) receiver 150. That is, the position information generator 133 of the UE 100 generates position data of the UE 100 based on a Positioning Reference Signal (PRS) (full PRS or partial PRS) received from the gNB 200. The position information generator 133 may receive a GNSS signal received by a GNSS receiver 150 (full GNSS signal or partial GNSS signal) and generate the position data of the UE 100 based on the GNSS signal.

As with the full CSI-RS, the gNB 200 transmits the full PRS by using a predetermined number of first resources (e.g., all antenna ports as illustrated in FIG. 9 or a predetermined number of time-frequency resources as illustrated in FIG. 10). As with the partial CSI-RS, the gNB 200 transmits the partial PRS by using the second resource (e.g., half the antenna ports in the antenna panel as illustrated in FIG. 9, or half the predetermined number of time-frequency resources as illustrated in FIG. 10) having the smaller number of resources than the first resources.

The full GNSS signal may be the GNSS signal continuously received in terms of time by the GNSS receiver 150. The partial GNSS signal may be the GNSS signal intermittently received by the GNSS receiver 150. That is, a predetermined number of the first resources may be used for the full GNSS signal, and the second resources having the smaller number of resources than the first resources may be used for the partial GNSS signal.

An operation example in the “positioning accuracy enhancement” can be implemented by replacing the “full CSI-RS” with the “full PRS”, the “partial CSI-RS” with the “partial PRS”, and the “CSI feedback” with the “position data”, respectively, in FIG. 11.

In the training mode (step S103), the position information generator 133 generates the position data of the UE 100 based on the full PRS received from the gNB 200. The position information generator 133 may receive a full GNSS signal received by the GNSS receiver 150 and generate the position data of the UE 100 based on the full GNSS signal. The transmitter 120 feeds back (or transmits) the position data to the gNB 200. The data collector A1 collects the full PRS (or the full GNSS signal) and the position data. The model training unit A2 creates a trained model with the full PRS (or the full GNSS signal) and the position data as the training data.

In the inference mode (step S108), the data collector A1 collects the partial PRS received by the receiver 110 (or the partial GNSS signal received by the GNSS receiver 150). The model inferrer A3 inputs the partial PRS (or the partial GNSS signal) to the trained model as the inference data, and obtains the position data as the inference result. The UE 100 transmits the inference result (position data) to the gNB 200 as the inference result data.

In the “positioning accuracy enhancement”, for example, at least either of the following data or information may be used as data that is used for the data set, in addition to the “PRS” (or the “GNSS signal”), and the “position data”.
(Z1) RSRP, RSRQ, Signal-to-interference-plus-noise ratio (SINR), or the output waveform of the AD converter (the measurement target data thereof may be the PRS or may be other received signals received from the gNB 200. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (trade name), or Bluetooth (trade name)
(Z7) Moving speed of the UE 100 (the moving speed may be measured by the GNSS receiver 150 or may be measured by a speed sensor in the UE 100. The moving speed may be measured by a speed sensor in the UE 100)

The UE 100 may transmit capability information to the gNB 200 as the control data, the capability information indicating which type of input data the UE 100 can handle in the machine learning. The capability information may include any information or data in (Z1) to (Z7). The capability information may include any information or data in (Z1) to (Z7), while separately handling the training data and the inference data. The gNB 200 may transmit data type information used as the data set to the UE 100 as the control data. The data type information may include, for example, any of data or information indicated in (Z1) to (Z7). The data type information may include, for example, any information or data in (Z1) to (Z7), while separately handling the training data and the inference data.

### (1.4) Other Arrangement Examples

Other arrangement examples will be described.

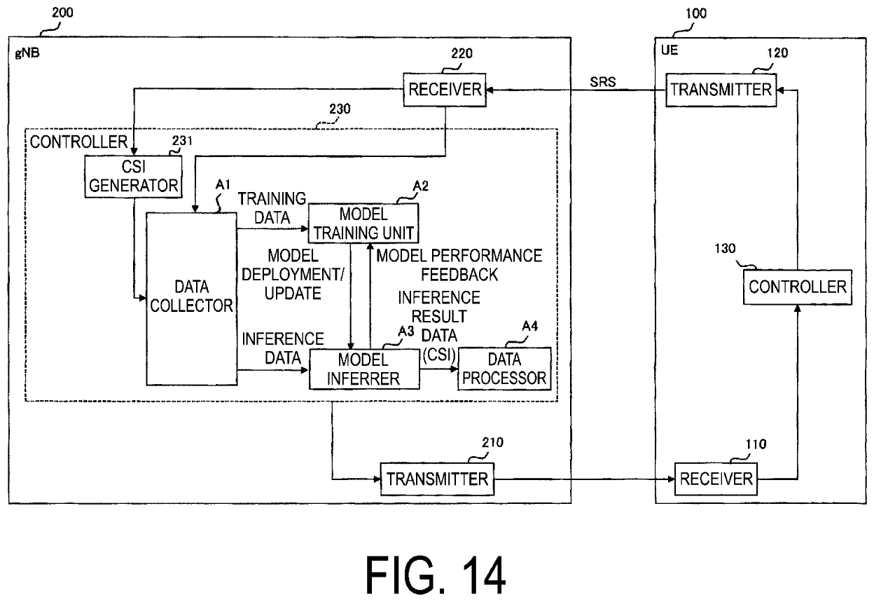

FIG. 14 is a diagram illustrating another arrangement example of the “CSI feedback enhancement” according to the first embodiment. FIG. 14 illustrates an example in which the gNB 200 includes the data collector A1, the model training unit A2, the model inferrer A3, and the data processor A4. That is, FIG. 14 is an example in which the model training and the model inference are performed in the gNB 200. FIG. 14 illustrates an example in which the transmission entity TE is the gNB 200 and the reception entity RE is the UE 100.

FIG. 14 illustrates an example in which the AI/ML technology is introduced into CSI estimation performed by the gNB 200 based on a Sounding Reference Signal (SRS). The gNB 200, therefore, includes a CSI generator 231 that generates the CSI based on the SRS. The CSI is information indicating an uplink channel state between the UE 100 and the gNB 200. The gNB 200 (e.g., the data processor A4) performs, for example, uplink scheduling based on the CSI generated based on the SRS.

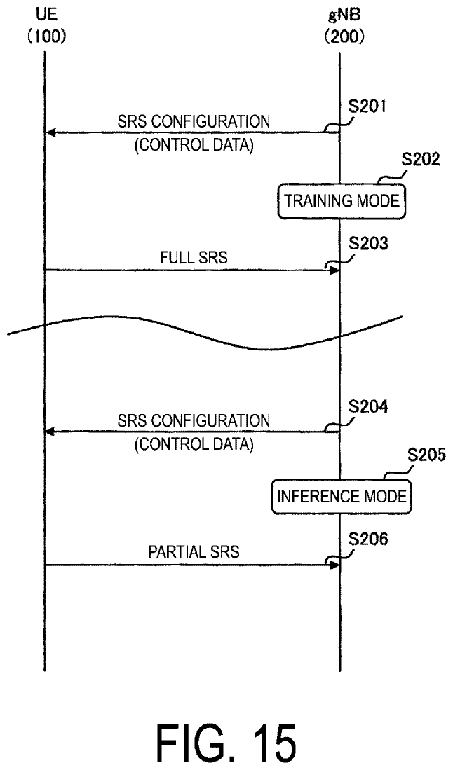

FIG. 15 is a diagram illustrating an operation example in another arrangement example according to the first embodiment.

As illustrated in FIG. 15, in step S201, the gNB 200 performs SRS transmission configuration for the UE 100. The SRS transmission configuration may include type information of the reference signal transmitted by the UE 100.

In step S202, the gNB 200 starts the training mode.

In step S203, the UE 100 transmits the full SRS to the gNB 200 in accordance with the SRS transmission configuration (step S201). The receiver 220 of the gNB 200 receives the full SRS. In the training mode, the CSI generator 231 generates (or estimates) the CSI based on the full SRS. The data collector A1 collects the full SRS and the CSI. The model training unit A2 creates a trained model with the full SRS and the CSI as the training data.

In step S204, the gNB 200 specifies the transmission pattern (puncture pattern) of the SRS to be input to the trained model as the inference data, and configures the specified SRS transmission pattern for the UE 100. The gNB 200 may transmit the SRS transmission configuration including the specified SRS transmission pattern to the gNB 200.

In step S205, the gNB 200 switches from the training mode to the inference mode. The gNB 200 starts the model inference by using the trained model.

In step S206, the UE 100 transmits the partial SRS in accordance with the SRS transmission configuration (step S204). When the gNB 200 inputs the SRS as the inference data to the trained model to obtain a channel estimation result, the gNB 200 performs uplink scheduling (e.g., control of uplink transmission weight and the like) of the UE 100 by using the channel estimation result. Note that when the inference accuracy by way of the trained model deteriorates, the gNB 200 may reconfigure, thus the UE 100 transmits the full SRS.

### (1.5) Arrangement Example When Federated Learning is Performed

There will be described an arrangement example of each of functional blocks when Federated learning is performed. The federated learning is, for example, one method of the machine learning in which machine learning is performed in a state that data (or a data set) is not aggregated but distributed. In the federated learning, because each entity needs not transmit data, the security of each entity can be ensured. The federated learning is said that can obtain a training result with accuracy equivalent to that of the centralized machine learning in the past.

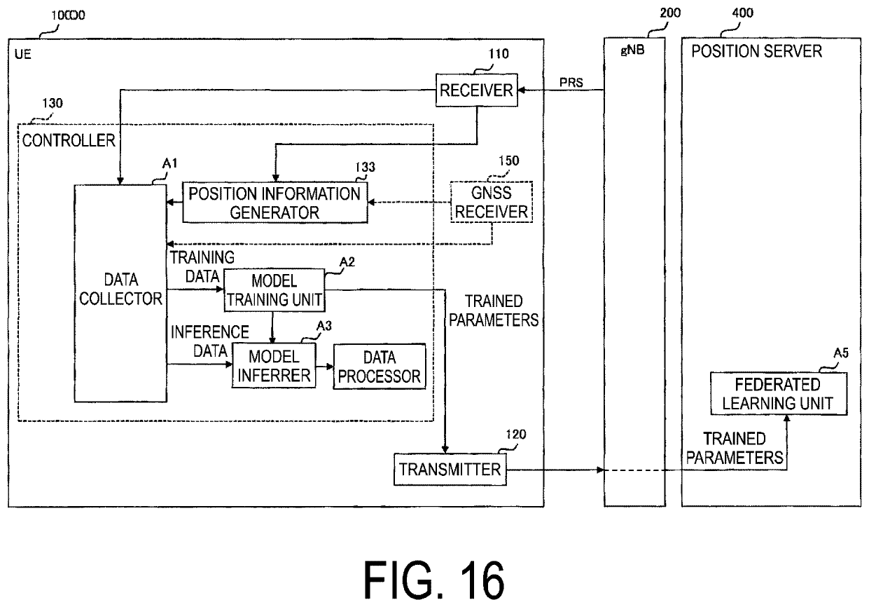

FIG. 16 is a diagram illustrating an arrangement example when the federated learning according to the first embodiment is performed. The example illustrated in FIG. 16 represents an example when the position estimation of the UE 100 is performed by using the federated learning. FIG. 16 illustrates an example in which the UE 100 includes the data collector A1, the model training unit A2, and the model inferrer A3. That is, an example is illustrated in which the model training and the model inference are performed in the UE 100. In FIG. 16, an example is illustrated in which the UE 100 is the transmission entity TE and the gNB 200 and/or a position server 400 is the reception entity RE.

The federated learning illustrated in FIG. 16 is performed in the following procedure, for example.

First, the position server 400 transmits a model to be the base of the model training to the UE 100.

Second, the UE 100 (model training unit A2) performs model training by using data present in the UE 100. The data present in the UE 100 is, for example, the PRS received from the gNB 200 and/or output data (GNSS signal) of the GNSS receiver 150. The data present in the UE 100 may include position data generated by the position information generator 133 based on the reception result of the PRS and/or the output data of the GNSS receiver 150.

Third, the UE 100 applies the trained model, which is the training result, in the model inferrer A3 and transmits variable parameters included in the trained model (hereinafter, the parameter may be referred to as “trained parameter”) to the position server 400. In the above-described example, each of the optimized a (slope) and b (intercept) corresponds to the trained parameter.

Fourth, the position server 400 (federated learning unit A5) collects the trained parameters from the multiple UEs 100 and integrates these parameters. The position server 400 may transmit the trained model obtained by the integration to the UE 100. The position server 400 can estimate the position of the UE 100 based on the trained model and a measurement report from the UE 100.

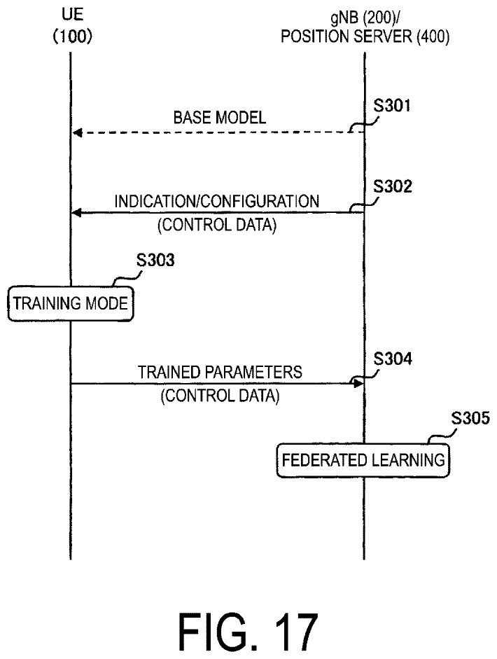

FIG. 17 is a diagram illustrating an operation example in the federated learning according to the first embodiment.

As illustrated in FIG. 17, in step S301, the gNB 200 may notify a model to be the base with which the UE 100 learns. The position server 400 may notify the model via the gNB 200.

In step S302, the gNB 200 instructs model training to the UE 100. The gNB 200 may configure a report timing (trigger condition) of the trained parameter. The report timing may be a periodic timing. The report timing may be a timing triggered when training progress satisfies a condition (i.e., an event trigger).

In step S303, the UE 100 starts the training mode. The UE 100 performs model training with the full PRS (or the full GNSS signal) and position data generated by the position information generator 133 as training data.

In step S304, when the condition of the report timing is satisfied, the UE 100 transmits the trained parameter at that time to the network (the gNB 200 or the position server 400).

In step S305, the position server 400 integrates the trained parameters reported from the multiple UEs 100.

### (1.6) Model Transfer Example

In (1.1) to (1.5), the arrangement examples of the functional blocks of the AI/ML technology have been described. Hereinafter, a model transfer example will be described. The model to be a transfer target may be a trained model used in the model inference. The model may be an untrained (or training in progress) model used in the model training.

### (1.6.1) First Operation Pattern relating to Model Transfer

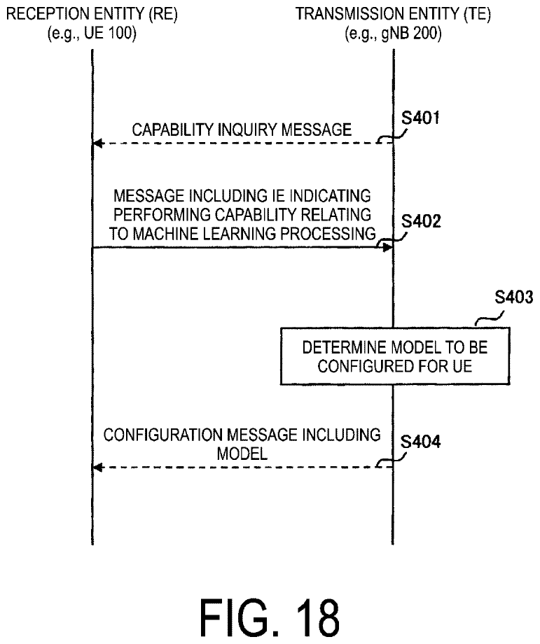

FIG. 18 is a diagram illustrating an operation example of a first operation pattern relating to model transfer according to the first embodiment. The example illustrated in FIG. 18 is described assuming that the reception entity RE is mainly the UE 100, but the reception entity RE may be the gNB 200 or the AMF 300. The example illustrated in FIG. 18 is described assuming that the transmission entity TE is the gNB 200, but the transmission entity TE may be the UE 100 or the AMF 300.

As illustrated in FIG. 18, in step S401, the gNB 200 transmits, to the UE 100, a capability inquiry message for requesting transmission of a message including an information element (IE) indicating performing capability relating to machine learning processing. The UE 100 receives the capability inquiry message. However, the gNB 200 may transmit the capability inquiry message when performing (when determining to perform) the machine learning processing.

In step S402, the UE 100 transmits, to the gNB 200, the message including the information element indicating the performing capability (a performing environment relating to the machine learning processing, from another viewpoint) relating to the machine learning processing. The gNB 200 receives the message. The message may be the RRC message (e.g., a “UE Capability” message or a newly defined message (e.g., a “UE AI Capability” message or the like)). The transmission entity TE may be the AMF 300 and the message may be a NAS message. When a new layer for performing or controlling the machine learning processing (AI/ML processing) is defined, the message may be a message of the new layer.

The information element indicating the performing capability relating to the machine learning processing may be an information element indicating the capability of the processor for performing the machine learning processing and/or an information element indicating the capability of the memory for performing the machine learning processing. The information element indicating the capability of the processor may be, specifically, an information element representing a product number (or a model number) of an AI processor. The information element indicating the capability of the memory may be, specifically, an information element indicating memory capacity.

The information element indicating the performing capability relating to the machine learning processing may be an information element indicating the performing capability of inference processing (model inference). The information element indicating the performing capability of the inference processing may be, specifically, an information element indicating whether a deep neural network model can be supported. The information element may be an information element indicating the time required to perform the inference processing (or response time).

The information element indicating the performing capability relating to the machine learning processing may be an information element indicating the performing capability of the training processing (model training). The information element indicating the performing capability of the training processing may be, specifically, an information element indicating the number of simultaneous performing of the training processing. The information element may be an information element indicating the processing capacity of the training processing.

In step S403, the gNB 200 determines a model to be configured (deployed) for the UE 100 based on the information element included in the message received in step S402.

In step S404, the gNB 200 transmits a message including the model determined in step S403 to the UE 100. The UE 100 receives the message and performs the machine learning processing (i.e., model training processing and/or model inference processing) by using the model included in the message. A specific example of step S404 will be described in a second operation pattern below.

### (1.6.2) Second Operation Pattern relating to Model Transfer

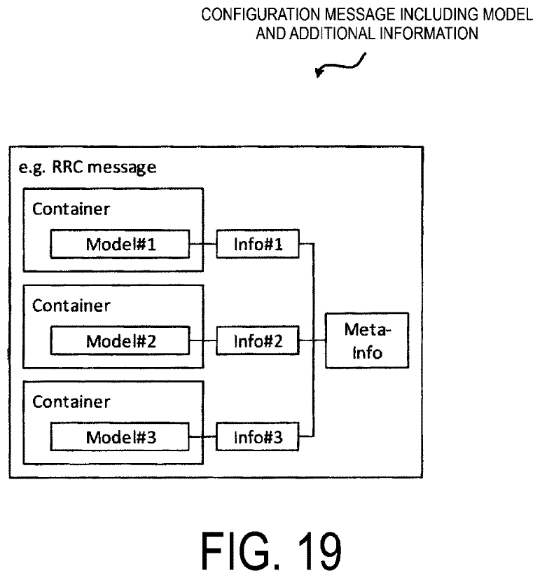

FIG. 19 is a diagram illustrating an example of a configuration message including models and additional information according to the first embodiment. The configuration message may be an RRC message transmitted from the gNB 200 to the UE 100 (e.g. an “RRC Reconfiguration” message or a newly defined message (e.g. an “AI Deployment” message or an “AI Reconfiguration” message, or the like)). The configuration message may be a NAS message transmitted from the AMF 300 to the UE 100. When a new layer for performing or controlling the machine learning processing (AI/ML processing) is defined, the message may be a message of the new layer.

In the example of FIG. 19, the configuration message includes three models (Model #1 to Model #3). Each model is included as a container of the configuration message. The configuration message may include only one model. The configuration message further includes, as additional information, three pieces of individual additional information (Info #1 to Info #3) and common additional information (Meta-Info). The three pieces of individual additional information are individually provided corresponding to three models (Model #1 to Model #3), respectively, and common additional information is commonly associated with the three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (e.g., processing delay) required for applying (performing) the model.

The individual additional information or the common additional information may be the use of a model for designating a function to which the model is applied (e.g., “CSI feedback”, “beam management”, “position measurement”, or the like). The individual additional information or the common additional information may be a model selection criterion for applying (performing) a corresponding model in accordance with the satisfaction of the designated criterion (e.g., a moving speed).

### (2) Communication Control Method according to First Embodiment

A communication control method according to the first embodiment will be described.

It is agreed in the 3GPP that the UE 100 may include multiple AI/ML models. However, there is no clear guidance as to which model may be used when the UE 100 includes multiple AI/ML models.

For example, when the UE 100 includes a predetermined AI/ML model for a predetermined use case (e.g., CSI feedback), there is a case that the predetermined AI/ML model is the best model in a certain region but is not the best model in another region. When the UE 100 includes a vendor-specific AI/ML model (i.e., an AI/ML model of vendor Proprietary Model) for the predetermined use case (e.g., CSI feedback), there is a case that the model is the best model in an RAN area supplied by the vendor but is not the best model in another RAN area supplied by another vendor in some cases.

As described above, when the UE 100 includes multiple AI/ML models in the same use case, there may be a case that which model to be used (as the best model) is not clear.

The first embodiment provides the UE 100 with the capability to appropriately perform the model inference by using the AI/ML model.

In the first embodiment, therefore, the base station (e.g., the gNB 200) transmits model information indicating information relating to each of the multiple first AI/ML models to the user equipment (e.g., the UE 100). Here, the base station holds the multiple first AI/ML models.

The model information is, for example, information relating to the AI/ML model held in the gNB 200. In the gNB 200, since the multiple AI/ML models are held, the model information represents information relating to each of the multiple AI/ML models.

The UE 100 receives the model information from the gNB 200. The UE 100, therefore, can select and use a model that matches the AI/ML model held by the itself from the AI/ML models included in the model information. The gNB 200 transmits information of the AI/ML model that the gNB 200 desires the UE 100 to use, which is included in the model information, thus the UE 100 can use the AI/ML model. As described above, the UE 100 can use an optimum AI/ML model based on the model information. Consequently, the UE 100 can appropriately perform model inference by using the AI/ML model.

### Terminology

Here, the terminology “AI/ML model” will be described. The “AI/ML model” is, for example, a data-driven algorithm to which an AI/ML technology is applied to generate a series of outputs based on a series of inputs. The process of training the “AI/ML model” may be “training of the AI/ML model”. The “training of the AI/ML model” is performed in the model training unit A2, for example. A process in which inference is performed by using the “AI/ML model” after training is “inference of AI/ML model”. The “inference of AI/ML model” is performed in the model inferrer A3, for example.

Hereinafter, the “AI/ML model” may simply be referred to as a “model”. Hereinafter, a model that does not use the AI/ML technology may be referred to as a “non-AI/ML model” or a “legacy model”. The non-AI/ML model includes a probability function, for example. When an input value is input to the probability function, an output value can be obtained without using the AI/ML model. In the example of a CSI feedback model, the conventional approach of obtaining the CSI from measurement values of the CSI-RS by using a codebook can be a non-AI/ML model.

### Operation Example According to First Embodiment

An operation example according to the first embodiment will be described.

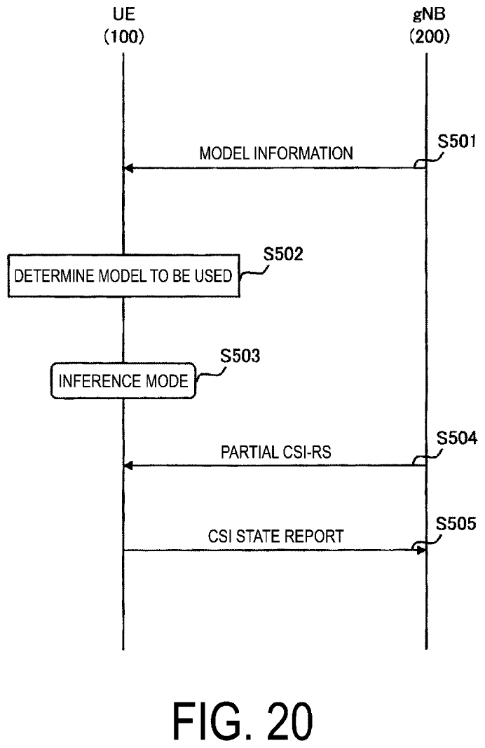

FIG. 20 is a diagram illustrating an operation example according to the first embodiment.

As illustrated in FIG. 20, in step S501, the gNB 200 transmits the model information to the UE 100.

First, the gNB 200 may transmit the model information to the UE 100 by using the RRC message such as an RRC reconfiguration (RRCReconfiguration) message. The gNB 200 may transmit the model information by using a new RRC message relating to the AI/ML model (e.g., a model response (Model Registration Response) message). A new layer (e.g., an AI/ML layer) for the AI/ML model may be defined, and the gNB 200 may transmit the model information to the UE 100 by using the new message in that layer.

Second, the model information may include model ID for identifying each of the multiple AI/ML models. The gNB 200 and the UE 100 each can identify each AI/ML model with the model ID. The model information may include a list of the multiple AI/ML models. The list may be represented with the model IDs. When the AI/ML model indicated with the model ID is the non-AI/ML model, information indicating being the non-AI/ML model (or legacy model) may be included in the model information. That is, the model information may include information relating to the non-AI/ML model.

Third, the model information may include designation information designating the AI/ML model that the gNB 200 desires the UE 100 to use among the multiple AI/ML models held by the gNB 200. When the UE 100 holds in itself the AI/ML model included in the designation information, the UE 100 performs the model inference by using the AI/ML model. When the UE 100 does not hold in itself the AI/ML model included in the designation information, the UE 100 may execute a Model Transfer procedure and receive the AI/ML model itself from the gNB 200.

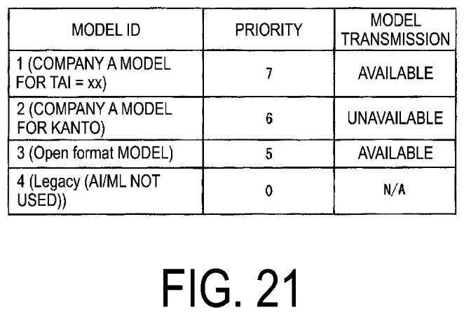

Fourth, the model information may include a priority. FIG. 21 is a table illustrating an example of the model information according to the first embodiment. The priority may represent the priority of each of the multiple AI/ML models when used by the UE 100. As illustrated in FIG. 21, the priority may be associated with each AI/ML model. The gNB 200 may determine the priority based on the circumstances of the AI/ML model. The circumstances of the AI/ML model include, for example, the inference accuracy of the AI/ML model (which is better than predetermined accuracy) and the training time (which is longer than predetermined training time). The gNB 200 may transmit to the UE 100 a reason for the priority in association with each AI/ML model together with the priority, which is included in the model information. For example, “priority: 7, reason: fastest execution time” or the like. Note that, in the example illustrated in FIG. 21, “7” has the highest priority and “0” has the lowest priority, but the order may be reversed.

The model information may include a priority execution condition. The priority execution condition represents, for example, priorities of the executable multiple AI/ML models when the accuracy of the AI/ML model is equal to or lower than an accuracy threshold value. The priority execution condition may represent priorities of the executable multiple AI/ML models when the likelihood of the AI/ML model is equal to or lower than a likelihood threshold value. For example, when the likelihoods become equal to or lower than the likelihood threshold value while the AI/ML models is used, the UE 100 can switch (or fall back) to the AI/ML model (with the highest priority) included in the priority execution condition in accordance with the priority in the priority execution condition. Note that, the fallback is, for example, switching from the AI/ML model to the non-AI/ML model (or the legacy model).

Fifth, the model information may include transmission availability information indicating whether or not Model Transfer from the gNB 200 to the UE 100 is allowed for each AI/ML model. The UE 100 can confirm whether or not the AI/ML model can be transmitted from gNB 200 based on the transmission availability information.

Sixth, the model information may include model information on the AI/ML model that matches a use condition (or is filtered by the use condition) among the multiple AI/ML models. The use condition indicates, for example, a condition when the AI/ML model is used in the UE 100. The AI/ML model may or may not be the optimum depending on the condition (or situation) in which the UE 100 is used. For example, the UE 100 can confirm under what condition the AI/ML model is used by confirming the use condition, and can appropriately perform model inference by using the AI/ML model under the condition (or situation) that matches the use condition. Examples of items included in the use condition are illustrated in Table 1 below.

TABLE 1

| Use condition | Example |
|---|---|
| Region or area | Position information based on a GNSS signal, |
| | Tracking Area Identity (TAI), Registration |
| | Area Identity (RAI), Public Land Mobile |
| | Network (PLMN), RAN Notification Area |
| | (RNA), NR Cell Global ID (NCGI), Physical |
| | Cell ID (PCI), a “list” of cells, |
| | or the like |
| Frequency or frequency | a < f < b, a < f, f < a, or the like Operating |
| range | band number (n257 or the like), Frequency |
| | Range (FR2 or the like), or the like. |
| Time or time range | a < t < b, or the like |
| Reference Signal | a < RSRP < b, a < RSRP, RSRP < a |
| Received Power (RSRP), | a < SINR < b, a < SINR, SINR < a, or |
| RSRP range, Signal to | the like |
| Interference plus Noise | |
| Ratio (SINR), SINR | |
| range, Reference Signal | |
| Received Quality | |
| (RSRQ), or RSRQ range | |
| Moving speed of UE | |
| 100, or latitude, | |
| longitude, altitude | |
| Model providing vendor | |
| Model format type | Proprietary-format or Open-format |
| Training situation | Small number of trainings to large number |
| | of trainings |
| Trained or untrained, | |
| training accuracy, | |
| reliability or credibility | |
| Training type | Unsupervised learning, supervised learning, |
| | reinforcement learning, deep reinforcement |
| | learning, semi-supervised learning, or |
| | the like |
| Model technique | Recurrent neural network (RNN), |
| | Convolutional Neural Network (CNN), |
| | or the like |
| Model providing source | gNB 200, AMF 300, or the like |
| Version information of | |
| model, training end time | |
| (timestamp) of model, | |
| training period of model | |
| A newly defined Model | Areas in which the model can be used are |
| Application Area (MAA) | represented in a list format |
| List (list including items | MAA #1 (PCI = A, PCI = B), MAA #2 |
| of use condition) | (frequency = x, frequency = y), |
| | or the like |

The model information may include model information relating to the AI/ML model that matches such use condition. For example, the gNB 200 may transmit one piece of model information including the model information of the AI/ML model corresponding to “vendor A” (“model providing vendor”) and the model information of the AI/ML model corresponding to “Open-format” (“model format type”). The UE 100 may transmit the use condition to be filtered (e.g., “vendor A”, “Open-format”, or the like) to the gNB 200. The use condition may be transmitted by the RRC message. The use condition may be transmitted by a new message of a new layer for the AI/ML model.

Seventh, when the UE 100 performs the handover, the gNB 200 may transmit the model information to the target gNB 200 being a handover destination of the UE 100. For example, the (source) gNB 200 may transmit the model information to the target gNB 200 by using an Xn message such as a handover request (HANDOVER REQUEST) message.

Note that the gNB 200 may transmit the model information to the UE 100 in a format (FIG. 21) in which the priority and/or the model transmission availability information is associated with each model ID. The gNB 200 may transmit the model information to the UE 100 in the format of the model ID associated with the priority for each priority (e.g., “model ID #1” for “priority “7”, “model ID #2, model ID #3” for “priority “6”, and the like). The gNB 200 may transmit the model information to the UE 100 in a format of the model ID associated with the model transmission availability information (e.g., “model ID #1” and “model ID #3” for “model transmission available”, “model ID #2” for “model transmission unavailable”, and the like).

Return to FIG. 20, in step S502, the UE 100 determines the AI/ML model to be used for the model inference based on the model information. The UE 100 may determine the model that matches the AI/ML model held by itself as a use target AI/ML model, from the AI/ML models included in the model information. The UE 100 may determine the AI/ML model designated in the designation information as the use target AI/ML model, or the UE 100 may determine the AI/ML model received from the gNB 200 as the use target AI/ML model.

In step S503, the UE 100 transitions to the inference mode. The UE 100 may transition to the inference mode before the stage of step S502.

In step S504, the gNB 200 transmits the partial (or punctured) CSI-RS.

In step S505, the UE 100 receives the CSI-RS and infers a CSI state report by using the AI/ML model determined in step S502. The UE 100 transmits the inferred CSI state report to the gNB 200.

### Other Example 1 According to First Embodiment

In the first embodiment, an example has been described in which the model information is transmitted from the gNB 200, but the transmission source of the model information is not limited to the gNB 200. For example, the model information may be transmitted from the AMF 300. In this case, the AMF 300 may transmit the model information to the UE 100 by using a NAS message. The transmission source of the model information may be an Over The Top (OTT) server that provides various content services such as a video distribution service. That is, the transmission source of the model information may be a network apparatus including the AMF 300 and the OTT server. The model information may be transmitted by using a message according to the predetermined protocol between the UE 100 and the network apparatus.

### Other Example 2 According to First Embodiment

In the first embodiment, the use case has been described with the CSI feedback as the example, but the use case is not limited thereto. For example, other use cases such as beam management or positioning accuracy enhancement may be used.

### Second Embodiment

A second embodiment will be described.

In the second embodiment, an example will be described in which the gNB 200 transmits the execution condition of an AI/ML model to the UE 100. Specifically, a base station (e.g., the gNB 200) transmits, to a user equipment (e.g., the UE 100), an execution condition indicating a condition for executing a predetermined operation for each of the multiple second AI/ML models. Here, the user equipment holds the multiple second AI/ML models.

The execution condition indicates, for example, a condition for executing the predetermined operation for each of the multiple AI/ML models. The “predetermined operation” is any of Activation for the AI/ML model, Deactivation for the AI/ML model, Switching of the AI/ML model, and Fallback of the AI/ML model. In the execution condition, for example, the condition for executing each of operations above is indicated for each AI/ML model.

The activation of the AI/ML model represents, for example, that the AI/ML model is activated and is in an executable state. The activation of the AI/ML model may be an executing state in which the AI/ML model is being executed. The deactivation of the AI/ML model represents, for example, that the AI/ML model is not in a usable state or that the AI/ML model is not usable.

The switching of the AI/ML model is, for example, switching from a first AI/ML model to a second AI/ML model that is an AI/ML model different from the first AI/ML model. The fallback of the AI/ML model is, for example, switching from the AI/ML model to a non-AI/ML model (or a legacy model).

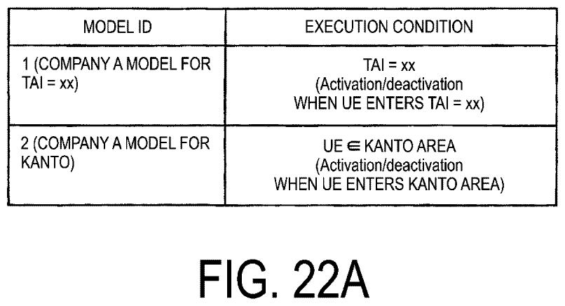

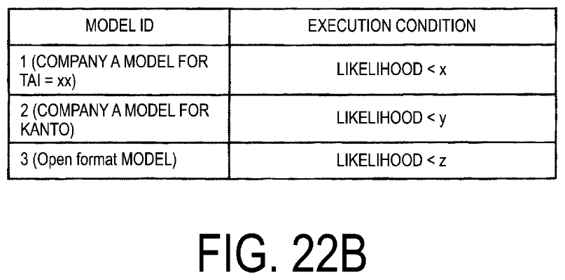

FIGS. 22A and 22B each are a table illustrating an example of the execution condition according to the second embodiment.

FIG. 22A illustrates an example of the execution condition of the activation (or the deactivation), for example. As illustrated in FIG. 22A, it is illustrated that the execution condition of the activation (or the deactivation) for the AI/ML model with the model ID=“1” is “TAI=xx”, that is, when the UE 100 enters a tracking area with TAI=xx, the activation (or the deactivation) for the AI/ML model with the model ID=“1” is executed.

FIG. 22B illustrates an example of the execution condition of the switching (or the fallback), for example. For example, when FIG. 22B illustrates the execution condition of the switching, it is illustrated that the execution condition of the switching of the AI/ML model with the model ID=“1” is “likelihood <x”, that is, when the likelihood of the AI/ML model with the model ID=“1” is lower than “x”, the UE 100 switches from the AI/ML model with the model ID=“1” to another AI/ML model. For example, when FIG. 22B illustrates the execution condition of the fallback, it is illustrated that the execution condition of the fallback of the AI/ML model with the model ID=“1” is “likelihood <x”, that is, when the likelihood of the AI/ML model with the model ID=“1” is lower than “x”, the UE 100 falls back from the AI/ML model with the model ID=“1” to the non-AI/ML model.

Note that the likelihood is, for example, an index representing a degree of likeliness. The higher the likelihood is, the higher the degree of likeliness of the AI/ML model is, and the lower the likelihood is, the lower the degree of likeliness of the AI/ML model is. The likelihood may represent likelihood of the AI/ML model when the non-AI/ML model is used as a comparison target.

As described above, the execution condition being represented for each AI/ML model makes it possible to report to the gNB 200 for each AI/ML model, when the UE 100 executes each operation. In the gNB 200, it becomes possible to recognize how the operation state of each AI/ML model is in the UE 100 with ease for each AI/ML model. In the gNB 200, it becomes possible to designate the AI/ML model used by the UE 100 or transmit the AI/ML model not held by the UE 100 (non-held AI/ML model) to the UE 100. Consequently, the UE 100 can appropriately perform model inference by using the AI/ML model. Furthermore, since the gNB 200 transmits the execution condition, the gNB 200 (or the network apparatus) can take the initiative to control the AI/ML model used in the UE 100.

### Operation Example According to Second Embodiment

An operation example according to the second embodiment will be described.

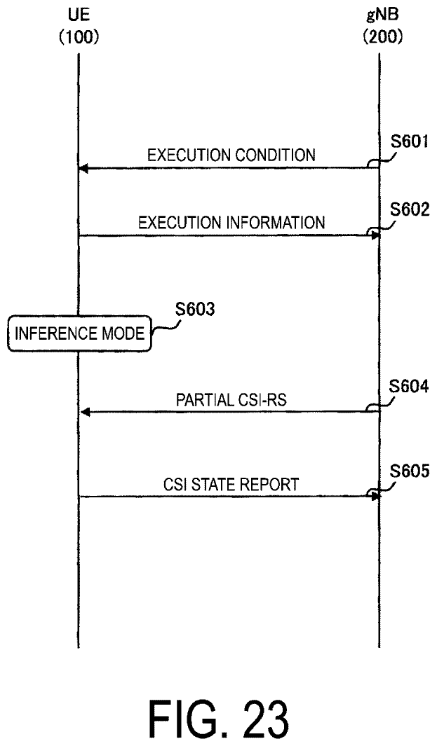

FIG. 23 is a diagram illustrating an operation example according to the second embodiment.

As illustrated in FIG. 23, in step S601, the gNB 200 transmits the execution condition to the UE 100.

First, the gNB 200 may transmit the execution condition by using an RRC message. A new layer (e.g., an AI/ML layer) may be defined, and the gNB 200 may transmit the execution condition by using a new message in that layer.

Second, the gNB 200 may transmit the model ID for identifying each AI/ML model together with the execution condition to the UE 100. Identifying each AI/ML model becomes possible with the model ID. The UE 100 becomes able to recognize what kind of execution condition is applied to each AI/ML model. For example, as illustrated in FIG. 22A or 22B, the execution condition may be transmitted in a list format for each AI/ML model. In the case above, in the list, identification information indicating the operation among the four operations may be added to each AI/ML model. For example, in FIG. 22A, information indicating “activation” or “deactivation” may be added to the list, and in FIG. 22B, information indicating “switching” or “fallback” may be added to the list.

Third, the execution condition may be represented by the use condition indicating a condition for the UE 100 to use the AI/ML model (or the second AI/ML model). For example, in the example of FIG. 22A, the execution condition is represented as a condition using “region or area” that is an item of the use condition (Table 1). As illustrated in FIG. 22B, the execution condition may include the likelihood. The likelihood may represent the accuracy of the AI/ML model in comparison with the non-AI/ML model.

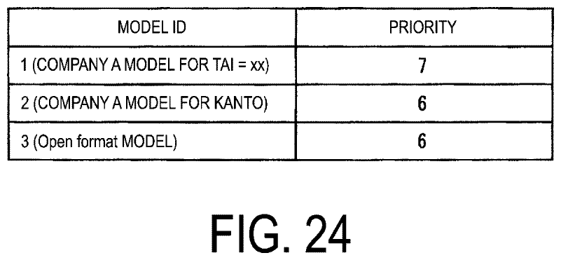

Fourth, a priority may be associated with the execution condition. FIG. 24 is a table illustrating an example of the priority according to the second embodiment. The priority represents, for example, which order the AI/ML models are executed when multiple AI/ML models satisfying the execution condition are present. For example, when the execution condition is “likelihood <x” (when the likelihood becomes lower than x), each AI/ML model is executed with the priority illustrated in FIG. 24. The gNB 200 may determine the priority based on the circumstances of the AI/ML model, as in the first embodiment. The circumstances of the AI/ML model include, for example, the inference accuracy of the AI/ML model (which is better than predetermined accuracy) and the training time (which is longer than predetermined training time). The gNB 200 may transmit to the UE 100 a reason for the priority in association with each AI/ML model together with the priority. For example, “priority: 7, reason: fastest execution time” or the like. Note that, the example in FIG. 24 represents an example in which the gNB 200 transmits the priority to the UE 100 separately from the execution condition, but the gNB 200 may transmit the priority to the UE 100 together with the execution condition. In the example illustrated in FIG. 24, “7” has the highest priority and “0” has the lowest priority, but the order may be reversed.

Fifth, the gNB 200 may designate to the UE 100 the AI/ML model that the UE 100 uses based on the execution condition. The designation may be transmitted from the gNB 200 to the UE 100 together with the execution condition. The designation may be transmitted from the gNB 200 to the UE 100 by using control data separately from the execution condition.

Sixth, when the UE 100 performs the handover, the gNB 200 may transmit the execution condition transmitted to the UE 100 (step S601) and/or the execution information (step S602) to the target gNB 200 (or the target base station) being the handover destination of the UE 100. For example, the (source) gNB 200 may transmit the execution condition and/or execution information to the target gNB 200 by using an Xn message such as a Handover Request (HANDOVER REQUEST) message. In the case above, the (source) gNB 200 may transmit the information transmitted to the UE 100 (the model ID, the priority (and the reason for the priority), and/or the information on the AI/ML model designated to the UE 100 by the gNB 200) to the target gNB 200 together with the execution condition and/or the execution information.

Note that the gNB 200 may transmit the execution condition in a format in which the execution condition is associated with each model ID (e.g., FIG. 22A). The gNB 200 may transmit the execution condition in a format in which the model ID is associated with the execution condition for each execution condition (e.g., “model ID #1” for “execution condition #1”, “model ID #2 and model ID #3” for “execution condition #2”, and the like).

Return to FIG. 23, in step S602, when the UE 100 executes the predetermined operation for the AI/ML model, the UE 100 transmits execution information to the gNB 200. For example, when the UE 100 has executed the predetermined operation for the AI/ML model, the execution information is information representing the having executed. The execution information may represent, for each AI/ML model, any of having executed the activation, having executed the deactivation, having executed the switching, and having executed the fallback. The gNB 200 may instruct the UE 100 to transmit the execution information when the operation has been executed. The instruction may be transmitted from the gNB 200 to the UE 100 by using the control data. The gNB 200 may instruct the UE 100 to execute the operation. The execution instruction of the operation may be transmitted from the gNB 200 to the UE 100 by using the control data. The execution instruction of the operation may include the model ID of the target AI/ML model. The UE 100 may execute the operation for the AI/ML model in accordance with the execution instruction of the operation.

First, the UE 100 may transmit the execution information to the gNB 200 when the UE 100 has executed the operation.

Second, when the UE 100 executes the operation, the UE 100 may store (log) the execution information in the memory and then collectively transmit the execution information to the gNB 200. In the case above, the UE 100 may transmit the stored execution information to the gNB 200 in response to a request from the gNB 200. The UE 100 may periodically transmit the stored execution information to the gNB 200. The gNB 200 may instruct the UE 100 to store the execution information and then transmit to the gNB 200. The request and the instruction from the gNB 200 may be transmitted to the UE 100 by using the control data. As described above, the UE 100 stores the execution information and transmits the execution information collectively at a later time, and thus the communication efficiency can be increased as compared with the case that the UE 100 transmits the execution information each time the UE 100 executes the operation.

The gNB 200 may determine to transmit the AI/ML model not held in the UE 100 (hereinafter, may be referred to as “non-held AI/ML model”) to the UE 100, based on the execution information. For example, when the gNB 200 recognizes that the “deactivation” continues for the predetermined AI/ML model, the gNB 200 determines that the non-held AI/ML model to be used as a substitute for the predetermined AI/ML model. In the case above, as in the first embodiment, the gNB 200 may transmit the non-held AI/ML model to the UE 100 by executing the model transmission procedure.

In step S603, the UE 100 transitions to the inference mode. The transition to the inference mode may be before the transmission of the execution information (step S602).

In step S604, the gNB 200 transmits the partial CSI-RS to the UE 100 and the UE 100 receives the CSI-RS.

In step S605, the UE 100 infers a CSI state report by using, for example, the AI/ML model satisfying the execution condition of the “activation”. The UE 100 may infer the CSI state report by using the AI/ML model with the highest priority when the priority is indicated. The UE 100 may infer the CSI state report by using the AI/ML model designated by the gNB 200. The UE 100 may infer the CSI state report by using the AI/ML model received from the gNB 200.

### Other Example 1 According to Second Embodiment

In the second embodiment, an example has been described in which the transmission source of the execution condition is the gNB 200, but not limited thereto. For example, the transmission source of the execution condition may be the AMF 300. The transmission source may be the OTT server. The transmission source may be another network apparatus. When the transmission source of the execution condition is the AMF 300, the execution condition, the execution information, the priority, and the like may be transmitted by using a NAS message. When the transmission destination of the execution condition is a network apparatus including the OTT server, the execution condition, the execution information, the priority, and the like may be transmitted by using a message according to a predetermined protocol between the UE 100 and the network apparatus.

### Other Example 2 According to Second Embodiment

In the second embodiment, the use case has been described with the CSI feedback as the example, but the use case is not limited thereto. For example, the use cases such as beam management or positioning accuracy enhancement may be used.

### Other Embodiments

When summarizing the first embodiment and the second embodiment described above, the gNB 200 can transmit at least either of the model information or the execution condition to the UE 100. Specifically, the base station (e.g., the gNB 200) transmits, to the user equipment (e.g., the UE 100), at least either of model information indicating information relating to each of the multiple first AI/ML models or the execution condition indicating a condition for executing the predetermined operation for each of the multiple second AI/ML models. Here, the base station holds the multiple first AI/ML models, and the user equipment holds the multiple second AI/ML models.

In the first embodiment and the second embodiment described above, the supervised learning has mainly been described, but not limited thereto. For example, the first embodiment and the second embodiment may be applied to the unsupervised learning or the reinforcement learning.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps need not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the apparatus of the core network and at least a part of the base station.

A program (e.g., information processing program) for causing a computer to execute each processing or each function according to the above-described embodiment may be provided. Alternatively, a program (e.g., mobile communication program) for causing the mobile communication system 1 to execute each processing or each function according to the above-described embodiment may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200. Circuits for executing processing performed by the UE 100 or the gNB 200 may be integrated, and at least a part of the UE 100 and the gNB 200 may be configured as a semiconductor integrated circuit (chipset, System on a chip (SoC)).

The functions achieved by the UE 100 or the gNB 200 (network node) may be implemented in circuitry or processing circuitry including general purpose processors and special purpose processors that are programmed to achieve the described functions, integrated circuits, Application Specific Integrated Circuits (ASICs), a Central Processing Unit (CPU), conventional circuits, and/or combinations thereof. The processor includes transistors and other circuits and is considered circuitry or processing circuitry. The processor may be a programmed processor that executes a program stored in the memory. In the present description, circuitry, units, means are hardware programmed to achieve, or hardware to perform, the described functions. The hardware may be any hardware disclosed in the present description, or any hardware programmed to achieve or known to execute the described functions. When the hardware is a processor that is considered to be a type of circuitry, the circuitry, means, or unit is a combination of hardware and software used for configuring the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure. It is also possible to combine each embodiment, each operation example, each process, and the like without contradicting.

### SUPPLEMENTARY NOTES

### Supplementary Note 1

A communication control method in a mobile communication system, the communication control method including:
a step of transmitting to a user equipment, by a network node, at least either of model information indicating information relating to a plurality of respective first AI/ML models or an execution condition indicating a condition for executing an operation predetermined for a plurality of respective second AI/ML models,
in which the network node holds the plurality of first AI/ML models and the user equipment holds the plurality of second AI/ML models.

### Supplementary Note 2

The communication control method according to Supplementary Note 1,
in which the model information includes designation information designating, among the plurality of first AI/ML models, the first AI/ML model that the network node desires for the user equipment to use.

### Supplementary Note 3

The communication control method according to Supplementary Note 1 or 2,
in which the model information includes a priority for the plurality of respective first AI/ML models.

### Supplementary Note 4

The communication control method according to any one of Supplementary Notes 1 to 3,
in which the model information includes transmission availability information indicating whether transmission to the user equipment is available for the plurality of respective first AI/ML models.

### Supplementary Note 5

The communication control method according to any one of Supplementary Notes 1 to 4,
in which the model information includes model information on the first AI/ML model, among the plurality of first AI/ML models, that matches a use condition.

### Supplementary Note 6

The communication control method according to any one of Supplementary Notes 1 to 5, further including:
a step of transmitting, by the user equipment, the use condition to the network node.

### Supplementary Note 7

The communication control method according to any one of Supplementary Notes 1 to 6,
in which the operation predetermined is any of activation of the second AI/ML model, deactivation of the second AI/ML model, switching of the second AI/ML model, and fallback of the second AI/ML model.

### Supplementary Note 8

The communication control method according to any one of Supplementary Notes 1 to 7,
in which the execution condition includes likelihood or accuracy of the second AI/ML model in comparison with a non-AI/ML model.

### Supplementary Note 9

The communication control method according to any one of Supplementary Notes 1 to 8,
in which the execution condition is represented by a use condition indicating a condition when the user equipment uses the second AI/ML model.

### Supplementary Note 10

The communication control method according to any one of Supplementary Notes 1 to 9,
in which the step of transmitting includes a step of transmitting to the user equipment, by the network node, the execution condition, and a priority for the plurality of respective second AI/ML models satisfying the execution condition.

### Supplementary Note 11

The communication control method according to any one of Supplementary Notes 1 to 10, further including:

a step of transmitting to the network node, by the user equipment, execution information representing that the operation is executed when the operation is executed for the plurality of respective second AI/ML models.

### Supplementary Note 12

The communication control method according to any one of Supplementary Notes 1 to 11, further including:
a step of instructing the user equipment, by the network node, to transmit the execution information.

### Supplementary Note 13

The communication control method according to any one of Supplementary Notes 1 to 12, further including:
a step of transmitting the execution information to the network node, by the user equipment, after the execution information is recorded.

### Supplementary Note 14

The communication control method according to any one of Supplementary Notes 1 to 13, further including:
a step of instructing the user equipment, by the network node, to transmit the execution information to the network node after the execution information is recorded.

### REFERENCE SIGNS

1: Mobile communication system
20: 5GC (CN)
100: UE
110: Receiver
120: Transmitter
130: Controller
200: gNB
210: Transmitter
220: Receiver
230: Controller
250: Backhaul communicator
A1: Data collector
A2: Model training unit
A3: Model inferrer
A4: Data processor
TE: Transmission entity
RE: Reception entity

1. A communication control method in a mobile communication system, the communication control method comprising:
transmitting to a user equipment, by a network node, at least either of model information indicating information relating to a plurality of respective first Artificial Intelligence (AI)/Machine Learning (ML) models or an execution condition indicating a condition for executing an operation predetermined for a plurality of respective second AI/ML models,
wherein the network node holds the plurality of first AI/ML models and the user equipment holds the plurality of second AI/ML models.

2. The communication control method according to claim 1,
wherein the model information comprises designation information designating, among the plurality of first AI/ML models, the first AI/ML model that the network node desires for the user equipment to use.

3. The communication control method according to claim 1,
wherein the model information comprises a priority for the plurality of respective first AI/ML models.

4. The communication control method according to claim 1,
wherein the model information comprises transmission availability information indicating whether transmission to the user equipment is available for the plurality of respective first AI/ML models.

5. The communication control method according to claim 1,
wherein the model information comprises model information on the first AI/ML model, among the plurality of first AI/ML models, that matches a use condition.

6. The communication control method according to claim 5, further comprising:
transmitting, by the user equipment, the use condition to the network node.

7. The communication control method according to claim 1,
wherein the operation predetermined is any of activation of the second AI/ML model, deactivation of the second AI/ML model, switching of the second AI/ML model, and fallback of the second AI/ML model.

8. The communication control method according to claim 7,
wherein the execution condition comprises likelihood or accuracy of the second AI/ML model in comparison with a non-AI/ML model.

9. The communication control method according to claim 7,
wherein the execution condition is represented by a use condition indicating a condition when the user equipment uses the second AI/ML model.

10. The communication control method according to claim 7,
wherein the transmitting comprises transmitting to the user equipment, by the network node, the execution condition, and a priority for the plurality of respective second AI/ML models satisfying the execution condition.

11. The communication control method according to claim 7, further comprising:
transmitting to the network node, by the user equipment, execution information representing that the operation is executed when the operation is executed for the plurality of respective second AI/ML models.

12. The communication control method according to claim 11, further comprising:
instructing the user equipment, by the network node, to transmit the execution information.

13. The communication control method according to claim 11, further comprising:
transmitting the execution information to the network node, by the user equipment, after the execution information is recorded.

14. The communication control method according to claim 13, further comprising:
instructing the user equipment, by the network node, to transmit the execution information to the network node after the execution information is recorded.

15. A network node in a mobile communication system, the network node comprising:
a transmitter that transmits to a user equipment at least either of model information indicating information relating to a plurality of respective first Artificial Intelligence (AI)/Machine Learning (ML) models or an execution condition indicating a condition for executing a predetermined operation for a plurality of respective second AI/ML models,
wherein the network node holds the plurality of first AI/ML models, and the user equipment holds the plurality of second AI/ML models.

16. A user equipment in a mobile communication system, the user equipment comprising:
a receiver that receives from a network node at least either of model information indicating information relating to a plurality of respective first Artificial Intelligence (AI)/Machine Learning (ML) models or an execution condition indicating a condition for executing a predetermined operation for a plurality of respective second AI/ML models,
wherein the network node holds the plurality of first AI/ML models, and the user equipment holds the plurality of second AI/ML models.
